(19) United States
(12) Patent Application Publication
(10) Pub. No.: US 2024/0020937 A1
(43) Pub. Date: Jan. 18, 2024

(54) INFORMATION PROCESSING SYSTEM, INFORMATION PROCESSING METHOD, AND PROGRAM

(71) Applicant: GREE, INC., Tokyo (JP)

(72) Inventor: Akihiko SHIRAI, Kanagawa (JP)

(73) Assignee: GREE, INC., Tokyo (JP)

(21) Appl. No.: 18/214,895

(22) Filed: Jun. 27, 2023

(30) Foreign Application Priority Data
Jul. 14, 2022 (JP) 2022-113449

(51) Int. Cl. G06T 19/20; G06T 13/40

(52) U.S. Cl. CPC G06T 19/20; G06T 13/40; G06T 2219/2004

(57) ABSTRACT

An information processing system includes one or more processors that generate, in a virtual space, a specific object that enables an avatar to move to a specific position or a specific area in the virtual space. The one or more processors also associate the specific object with (i) a condition for using the specific object and (ii) information regarding at least one of (a) an attribute of the specific object and (b) an attribute of the specific position or an attribute of the specific area.

This application claims the benefit of priority from Japanese Patent Application No. 2022-113449 filed Jul. 14, 2022, the entire contents of the prior application being incorporated herein by reference.

### TECHNICAL FIELD

This disclosure relates to an information processing system, an information processing method, and a program.

### BACKGROUND TECHNOLOGY

A technology is known that controls a position relationship between users in a virtual space.

### SUMMARY

Problems to be Resolved

However, it is difficult to appropriately support movement of an avatar in a virtual space with conventional technology.

Therefore, in one aspect, an object of this disclosure is to appropriately support movement of an avatar within a virtual space.

[Means of Solving Problems]

In one aspect, an information processing system is provided that includes:

a specific object generator that generates a specific object that enables an avatar to move to a specific position in a virtual space, or to a specific area in the virtual space; and

an association processor that associates, with the specific object, information of at least one of (i) a usage condition of the specific object and (ii) an attribute of the specific object or an attribute of a specific destination of the specific object.

[Effects]

In one aspect, according to this disclosure, movement of an avatar within a virtual space is appropriately supported.

### BRIEF DESCRIPTION OF DRAWINGS

FIG. 1 is a block diagram of a virtual reality generation system according to this embodiment.

FIG. 2 is an explanatory diagram of a terminal image that can be viewed via a head-mounted display.

FIG. 3 is an explanatory diagram of operation input by a gesture.

FIG. 4 is an explanatory diagram of an example of a virtual space that can be generated by the virtual reality generation system.

FIG. 5 is a chart showing an example of attributes of a portal that can be set in this embodiment.

FIG. 6 is an explanatory diagram showing an example of a usage condition of a portal.

FIG. 7 is an illustration that schematically shows a state of moving through a portal.

FIG. 8A is an explanatory diagram of an example of a guide process through a first agent avatar that is associated with each avatar.

FIG. 8B is an explanatory diagram of an example of a guide process through a first agent avatar that is associated with each avatar.

FIG. 9 is an explanatory diagram of second agent avatars that are each linked with a position or an area.

FIG. 10 is an explanatory diagram showing a situation of a plurality of avatars waiting to use a specific portal.

FIG. 11 is an example of a functional block diagram of a server device related to a portal function.

FIG. 12 is an explanatory diagram of data within a portal information memory.

FIG. 13 is an explanatory diagram of data within a user information memory.

FIG. 14 is an explanatory diagram of data within an agent information memory.

FIG. 15 is an explanatory diagram of data within an avatar information memory.

FIG. 16 is an explanatory diagram of data within a usage status/history memory.

FIG. 17 is an outline flowchart showing an operation example relating to portal generation processing through a portal-related processor.

FIG. 18 is an outline flowchart showing an operation example relating to guidance processing through a guidance setting portion.

FIG. 19 is an outline flowchart showing an operation example relating to processing through a movement processor.

FIG. 20 is an outline flowchart showing an operation example relating to memory recording processing through a movement processor.

### MODES FOR IMPLEMENTING EMBODIMENTS

Hereinafter, various embodiments will be described with reference to the drawings. In the attached drawings, for ease of viewing, only a portion of a plurality of parts having the same attribute may be given reference numerals.

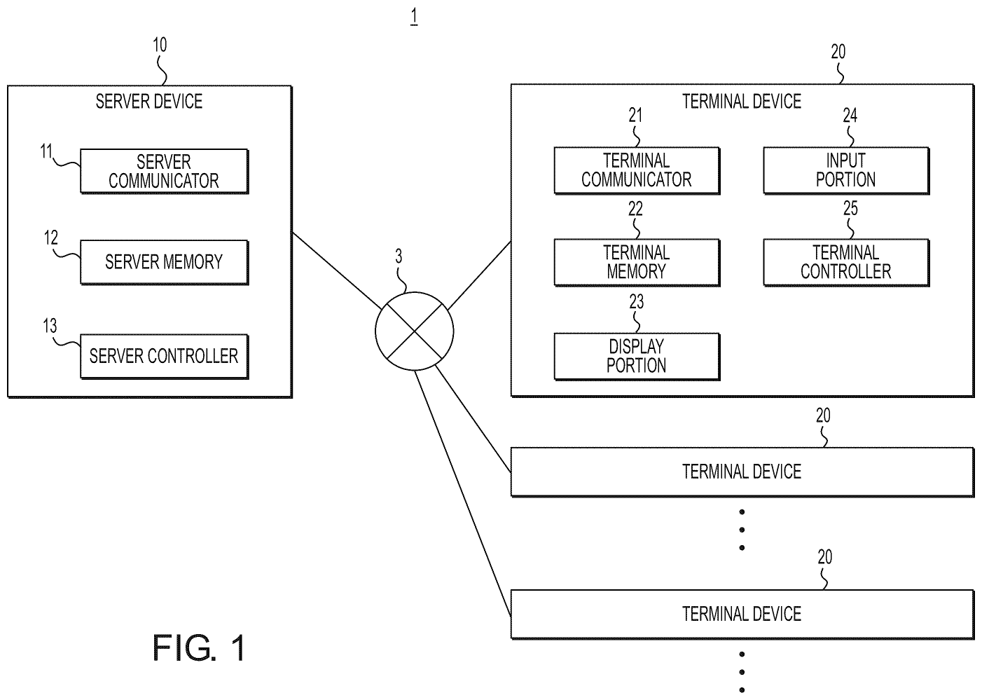

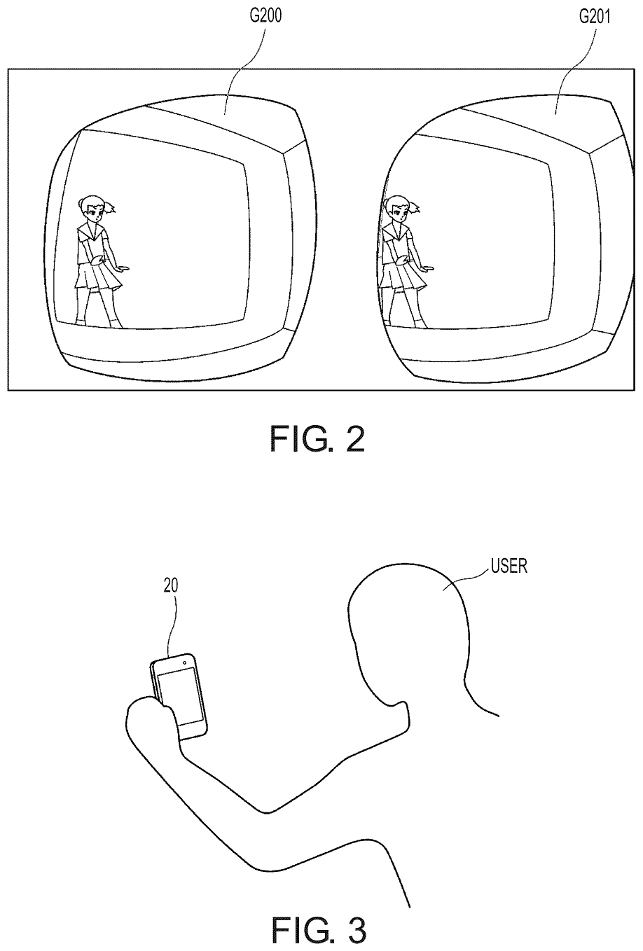

With reference to FIG. 1, an overview of a virtual reality generation system 1 according to an embodiment will be described. FIG. 1 is a block diagram of a virtual reality generation system 1 according to this embodiment. FIG. 2 is an explanatory diagram of a terminal image that can be viewed through a head-mounted display.

The virtual reality generation system 1 includes a server device 10 and one or more terminal devices 20. Although three terminal devices 20 are illustrated in FIG. 1 for simplicity, the number of terminal devices 20 may be two or more.

The server device 10 is an information system, for example, a server or the like managed by an administrator who provides one or more virtual realities. The terminal device 20 is a device used by a user, such as a mobile phone, a smartphone, a tablet terminal, a PC (Personal Computer), a head-mounted display, a game device, or the like. The terminal device 20 is typically different for each user. A plurality of terminal devices 20 can be connected to the server device 10 via a network 3.

The terminal device 20 can execute a virtual reality application according to this embodiment. The virtual reality application may be received by the terminal device 20 from the server device 10 or a predetermined application distribution server via the network 3. Alternatively, it may be stored in advance in a memory device provided in the terminal device 20 or in a memory medium such as a memory card that can be read by the terminal device 20. The server device 10 and the terminal device 20 are communicably connected via the network 3. For example, the server device 10 and the terminal device 20 cooperate to perform various processes related to virtual reality.

The terminal devices 20 are communicably connected to each other via the server device 10. Hereinafter, “one terminal device 20 sends information to another terminal device 20” means “one terminal device 20 sends information to another terminal device 20 via the server device 10.” Similarly, “one terminal device 20 receives information from another terminal device 20” means “one terminal device 20 receives information from another terminal device 20 via the server device 10.” However, in a modification, each terminal device 20 may be communicably connected without going through the server device 10.

The network 3 may include a wireless communication network, the Internet, a VPN (Virtual Private Network), a WAN (Wide Area Network), a wired network, or any combination of these, or the like.

Hereinafter, the virtual reality generation system 1 realizes an example of the information processing system, but each element of a specific terminal device 20 (see a terminal communication portion 21 to a terminal controller 25 in FIG. 1) may realize an example of the information processing system. Alternatively, a plurality of terminal devices 20 may work together to realize an example of the information processing system. Additionally, the server device 10 alone may realize an example of the information processing system. Alternatively, the server device 10 and one or more terminal devices 20 may work together to realize an example of an information processing system.

Here, a summary of a virtual reality according to this embodiment will be described. A virtual reality according to this embodiment is, for example, a virtual reality for any reality such as education, travel, role-playing, simulation, entertainment such as games and concerts, or the like. A virtual reality medium such as an avatar is used in execution of the virtual reality. For example, a virtual reality according to this embodiment may be realized by a three-dimensional virtual space, various virtual reality media that appear in the virtual space, and various contents provided in the virtual space.

Virtual reality media are electronic data used in virtual reality, and include any medium such as cards, items, points, in-service currency (or virtual reality currency), tokens (for example, Non-Fungible Token (NFT)), tickets, characters, avatars, parameters, or the like. Additionally, virtual reality media may be virtual reality-related information such as level information, status information, parameter information (physical strength, offensive ability, or the like) or ability information (skills, abilities, spells, jobs, or the like). Furthermore, the virtual reality media are electronic data that can be acquired, owned, used, managed, exchanged, combined, reinforced, sold, disposed of, or gifted or the like by a user in the virtual reality. However, usage of the virtual reality media is not limited to those specified in this specification.

An avatar is typically in the form of a character with a frontal orientation, and may have a form of a person, an animal, or the like. An avatar can have various appearances (appearances when drawn) by being associated with various avatar items. Additionally, hereinafter, due to the nature of avatars, a user and an avatar may be treated as the same. Therefore, for example, “one avatar does XX” may be synonymous with “one user does XX.”

A user may wear a mounted device on the head or a part of the face and visually recognize a virtual space through the mounted device. The mounted device may be a head-mounted display or a glasses-type device. A glasses-type device may be so-called AR (Augmented Reality) glasses or so-called MR (Mixed Reality) glasses. In any case, the mounted device may be separate from the terminal device 20, or may realize part or all of functions of the terminal device 20. The terminal device 20 may be realized by a head-mounted display.

### (Configuration of Server Device)

A configuration of the server device 10 will be described in detail. The server device 10 is constituted by a server computer. The server device 10 may be realized by a plurality of server computers working together. For example, the server device 10 may be realized by a server computer that provides various contents, a server computer that realizes various authentication servers, and the like. Additionally, the server device 10 may also include a Web server. In this case, some functions of the terminal device 20 described hereafter may be realized by a browser processing HTML documents received from the Web server and various programs (JavaScript) associated with them.

As shown in FIG. 1, the server device 10 includes a server communicator 11, a server memory 12, and a server controller 13.

The server communicator 11 includes an interface that communicates with an external device wirelessly or by wire to send and receive information. The server communicator 11 may include, for example, a wireless LAN (Local Area Network) communication module or a wired LAN communication module or the like. The server communicator 11 can send and receive information to and from the terminal devices 20 via the network 3.

The server memory 12 is, for example, a memory device, and stores various information and programs necessary for various processes related to virtual reality.

The server controller 13 may include a dedicated microprocessor or a CPU (Central Processor) that performs specific functions by loading a specific program, a GPU (Graphics Processor), and the like. For example, the server controller 13 cooperates with the terminal device 20 to execute a virtual reality application in response to user input.

The server controller 13 (and the same applies to the terminal controller 25 described hereafter) can be configured as circuitry that includes one or more processors that operate in accordance with a computer program (software), one or more dedicated hardware circuits that execute at least part of the processes among various processes, or a combination of these.

### (Configuration of Terminal Device)

A configuration of the terminal device 20 will be described. As shown in FIG. 1, the terminal device 20 is provided with a terminal communicator 21, a terminal memory 22, a display portion 23, an input portion 24, and a terminal controller 25.

The terminal communicator 21 communicates with an external device wirelessly or by wire, and includes an interface for sending and receiving information. The terminal communicator 21 may include, for example, a wireless communication module, a wireless LAN communication module, or a wired LAN communication module, or the like corresponding to a mobile communication standard such as LTE (Long Term Evolution) (registered trademark), LTE-A (LTE-Advanced), a fifth generation mobile communications system, or UMB (Ultra Mobile Broadband). The terminal communicator 21 can send and receive information to and from the server device 10 via the network 3.

The terminal memory 22 includes, for example, primary and secondary memory devices. For example, the terminal memory 22 may include a semiconductor memory, a magnetic memory, or optical memory, or the like. The terminal memory 22 stores various information and programs used in the processing of virtual reality that are received from the server device 10. The information and programs used in the processing of virtual reality may be acquired from an external device via the terminal communicator 21. For example, a virtual reality application program may be acquired from a predetermined application distribution server. Hereinafter, an application program is also referred to simply as an application.

Additionally, the terminal memory 22 may store data for drawing a virtual space, for example, an image of an indoor space such as a building, an image of an outdoor space, or the like. Also, a plurality of types of data for drawing a virtual space may be prepared for each virtual space and used separately.

Additionally, the terminal memory 22 may store various images (texture images) for projection (texture mapping) onto various objects placed in a three-dimensional virtual space.

For example, the terminal memory 22 stores avatar drawing information related to avatars as virtual reality media associated with each user. An avatar in the virtual space is drawn based on the avatar drawing information related to the avatar.

Also, the terminal memory 22 stores drawing information related to various objects (virtual reality media) different from avatars, for example, various gift objects, buildings, walls, NPCs (Non Player Characters), and the like. Various objects are drawn in the virtual space based on such drawing information. A gift object is an object that corresponds to a gift from one user to another user, and is part of an item. A gift object may be a thing worn by an avatar (clothes or accessories), a decoration (fireworks, flowers, or the like), a background (wallpaper), or the like, or a ticket or the like that can be used for gacha (lottery). The term “gift” used in this application means the same concept as the term “token.” Therefore, it is also possible to replace the term “gift” with the term “token” to understand the technology described in this application.

The display portion 23 includes a display device, for example, a liquid crystal display or an organic EL (Electro-Luminescent) display. The display portion 23 can display various images. The display portion 23 is constituted by, for example, a touch panel, and functions as an interface that detects various user operations. Additionally, as described above, the display portion 23 may be in the form of being incorporated into a head-mounted display.

The input portion 24 may include physical keys or may further include any input interface, including a pointing device such as a mouse or the like. The input portion 24 may also be able to accept non-contact-type user input, such as sound input, gesture input, or line-of-sight input. Gesture input may use sensors (image sensors, acceleration sensors, distance sensors, and the like) to detect various user states, special motion capture that integrates sensor technology and a camera, a controller such as a joypad, or the like. Also, a line-of-sight detection camera may be arranged in a head-mounted display. The user's various states are, for example, the user's orientation, position, movement, or the like. In this case, the orientation, position, and movement of the user include not only the orientation, position, and movement of part or all of the user's body, such as the face and hands, but also the orientation, position, movement, and the like of the user's line of sight.

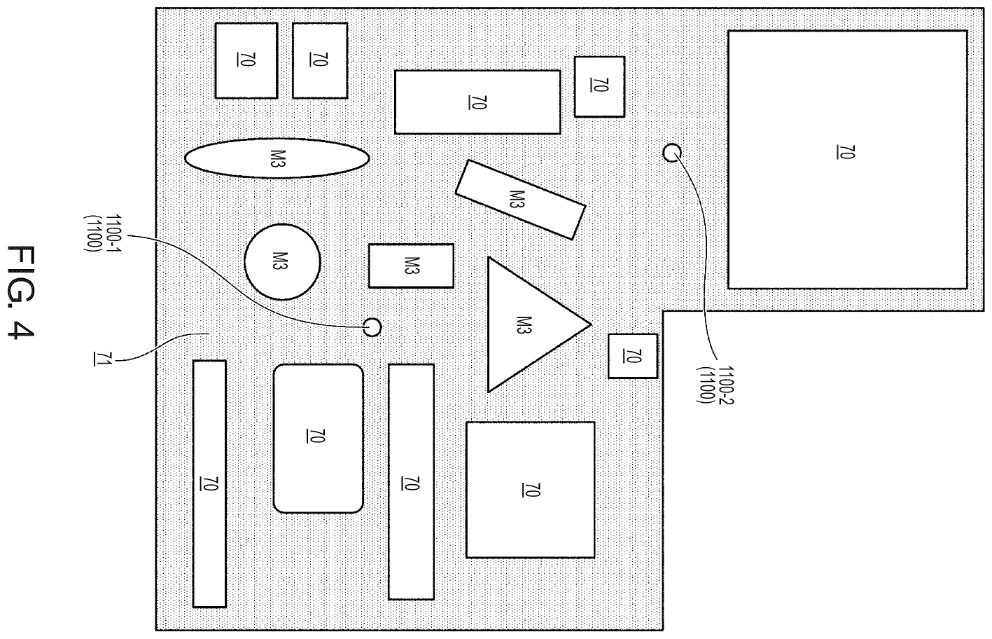

Operation input by gestures may be used to change a viewpoint of a virtual camera. For example, when a user changes a direction of the terminal device 20 while holding the terminal device 20 with his or her hand as schematically shown in FIG. 3, the viewpoint of the virtual camera may be changed according to the direction. In this case, even when using a terminal device 20 with a relatively small screen such as a smartphone, a wide viewing area can be ensured in the same manner as the surroundings can be looked around via a head-mounted display.

The terminal controller 25 includes one or more processors. The terminal controller 25 controls the overall operation of the terminal device 20.

The terminal controller 25 sends and receives information via the terminal communicator 21. For example, the terminal controller 25 receives various information and programs used for various processes related to virtual reality from at least one of (i) the server device 10 and (ii) another external server. The terminal controller 25 stores the received information and programs in the terminal memory 22. For example, the terminal memory 22 may contain a browser (Internet browser) for connecting to a Web server.

The terminal controller 25 activates a virtual reality application in response to a user operation. The terminal controller 25 cooperates with the server device 10 to execute various processes related to virtual reality. For example, the terminal controller 25 displays an image of the virtual space on the display portion 23. On the screen, for example, a GUI (Graphical User Interface) may be displayed that detects a user operation. The terminal controller 25 can detect a user operation via the input portion 24. For example, the terminal controller 25 can detect various operations by user gestures (operations corresponding to a tap operation, a long tap operation, a flick operation, a swipe operation, and the like). The terminal controller 25 sends the operation information to the server device 10.

The terminal controller 25 draws an avatar or the like together with the virtual space (image), and causes the display portion 23 to display a terminal image. In this case, for example, as shown in FIG. 2, a stereoscopic image for a head-mounted display may be generated by generating images G200 and G201 that can be viewed with the right and left eyes, respectively. FIG. 2 schematically shows the images G200 and G201 that can be viewed by the right and left eyes, respectively. Hereinafter, unless otherwise specified, images in the virtual space refer to the entire images represented by the images G200 and G201. Additionally, the terminal controller 25 realizes various movements of the avatar in the virtual space, for example, according to various operations by a user.

The virtual space described below is an immersive space that can be viewed using a head-mounted display or the like, and is a concept that includes not only a continuous three-dimensional space in which the user can freely (like in real life) move around via an avatar, but also a non-immersive space that can be viewed using a smartphone or the like as described above with reference to FIG. 3. Additionally, a non-immersive space that can be viewed using a smartphone or the like may be a continuous three-dimensional space in which the user can freely move around via an avatar, or a two-dimensional discontinuous space. Hereinafter, when distinguishing, a continuous three-dimensional space in which a user can freely move around via an avatar is also referred to as a “metaverse space.”

Also, various objects and facilities (for example, movie theaters) that appear in the following description are objects in a virtual space and are different from real objects, unless otherwise specified. In addition, various events in the following description are various events in a virtual space (for example, screenings of movies and the like), and are different from events in reality.

Additionally, hereinafter, any virtual reality medium different from an avatar (for example, a building, a wall, a tree, an NPC, or the like) and drawn in the virtual space is also referred to as a second object M3. In this embodiment, the second object M3 may include an object that is fixed within the virtual space, an object that is movable within the virtual space, or the like. Also, the second object M3 may include an object that is always arranged in the virtual space, an object that is arranged only when a predetermined arrangement condition is satisfied, or the like.

FIG. 4 is an explanatory diagram of an example of a virtual space that can be generated by the virtual reality generation system.

In the example shown in FIG. 4, the virtual space includes a plurality of flea market spatial portions 70 and a free spatial portion 71. In the free spatial portion 71, an avatar can basically move freely. In this case, each spatial portion 70 may be a local division called a world, and the entire virtual space may be a global space. A part or all of the plurality of spatial portions 70 may be part of a virtual space constructed by one platformer, or may be a virtual space itself constructed by a plurality of different platformers.

Each spatial portion 70 may be a spatial portion at least partially separated from the free spatial portion 71 by a wall (example of a second object M3) or a movement-prohibiting portion (example of a second object M3). For example, a spatial portion 70 may have a doorway (for example, a second object M3 such as a hole or a door) through which a user avatar M1 can enter and exit the free spatial portion 71. In the spatial portion 70, content may be provided to a user avatar M1 positioned in the spatial portion 70.

A spatial portion 70 may be a spatial portion at least partially separated from the free spatial portion 71 by a wall (an example of a predetermined object to be described later) or a movement-prohibiting portion (an example of a predetermined object to be described later). For example, a spatial portion 70 may have a doorway (for example, a predetermined object such as a hole or a door) through which the avatar can enter and exit the free spatial portion 71. Although the spatial portions 70 and the free spatial portion 71 are drawn in a two-dimensional plane in FIG. 4, the spatial portions 70 and the free spatial portion 71 may be set as a three-dimensional space. For example, the spatial portions 70 and the free spatial portion 71 may be spaces having walls and a ceiling in a range corresponding to the planar shape shown in FIG. 4 as the floor. In addition to the example shown in FIG. 4, the spatial portions 70 and the free spatial portion 71 may be spaces with heights such as domes and spheres, structures such as buildings, specific places on the earth, or a world imitating outer space where avatars can fly around.

The plurality of spatial portions 70 may include spatial portions for providing content. The free spatial portion 71 may also be appropriately provided with content (for example, various content provided in the spatial portions 70, such as will be described hereafter).

The type and number of contents provided in the spatial portions 70 (contents provided in virtual reality) are arbitrary. In this embodiment, as an example, the content provided in each spatial portion 70 includes digital content such as various videos. A video may be a real-time video or a non-real-time video. Also, a video may be a video based on a real image, or may be a video based on CG (Computer Graphics). The video may be a video for providing information. In this case, the video may be related to an information provision service of a specific genre (information provision service related to travel or housing, food, fashion, health, beauty, or the like), broadcast services by a specific user (for example, YouTube (registered trademark)), or the like.

The content provided in each spatial portion 70 may be various items (an example of a second object) that can be used in the virtual space. In this case, the spatial portion 70 that provides various items may be in the form of a store. Alternatively, the content provided in each spatial portion 70 may be an acquisition authorization or a token for an actually obtainable item, or the like. Some of the plurality of spatial portions 70 may be spatial portions that do not provide content.

Each of the spatial portions 70 may be operated by a different entity, similar to a real physical store. In this case, the operator of each spatial portion 70 may use the corresponding spatial portion 70 by paying a store opening fee or the like to the operator of the virtual reality generation system 1.

Additionally, the virtual space may be expandable as the number of the spatial portions 70 increases. Alternatively, a plurality of virtual spaces may be set for each attribute of content provided in the spatial portions 70. In this case, the virtual spaces may be discontinuous with respect to each other as “spatial portions,” or may be continuous.

Incidentally, in a metaverse space, many avatars can freely move around. However, in the case of a destination that takes a long time to move to with a normal moving method, such as a relatively distant location, it is useful to appropriately support the movement of the avatar to the destination.

Therefore, in this embodiment, in a virtual space, a portal is generated as a specific object that enables an avatar to move to a specific position or area.

In this embodiment, portals may be set at a destination and an origin, respectively. In this case, an avatar can move directly between two portals. Furthermore, the time required to directly move between the two areas associated with the two portals may be significantly shorter than the time required to move the avatar between the two areas based on movement operation input. As a result, the user can realize efficient movement, using the portals. In addition, in a modified example, the portals may include not only a type that enables bidirectional movement, but also a type that enables only one-way movement. As will be described later, a plurality of portals may be set in the virtual space in a manner having a plurality of types of attributes.

In the virtual space shown in FIG. 4, an example of portals 1100 are set. Positions of the portals 1100 may be fixed or may be changed as appropriate. Furthermore, the portals 1100 may appear when a predetermined appearance condition is met. A destination from the portal 1100 may be set for each portal 1100. The destination from each portal 1100 does not necessarily have to be a space different from a space to which the current position belongs (for example, a discontinuous space), and may be set within the same space as the space to which the current position belongs.

In this embodiment, a portal (return portal) corresponding to one portal 1100 may be set in a destination space or the like in a manner that allows direct movement between two positions or areas. In this case, bi-directional movement through the portals is possible. For example, FIG. 4 schematically shows a pair of portals 1100-1, 1100-2. In this case, passing through one of the portals 1100-1 and 1100-2 can realize instantaneous movement (hereinafter referred to as “teleportation”) to the other position. Teleportation between two points (for example, teleportation between the pair of portals 1100-1 and 1100-2) is a movement mode that cannot be realized in reality. For example, it refers to a movement mode in which a user avatar M1 can be moved in a significantly shorter time than the minimum time required to move the user avatar M1 between two points by a movement operation input.

Here, even in the same physical space, a portal (for example, a portal in the form of a mirror or the like) in CG (Computer Graphics) superimposed as AR (Augmented Reality) may be installed as a partition wall, and the portal may have a role of join events or spaces in the metaverse. In this case, the avatar may enter an event or space in the metaverse by contacting or passing through the portal.

In the example shown in FIG. 4, the two portals 1100 are set within the free spatial portion 71, but one or both of the two portals 1100 may be set within a spatial portion 70. Also, there may be two or more destinations that can be teleported to from one portal, and these destinations may be selected by the user or selected at random.

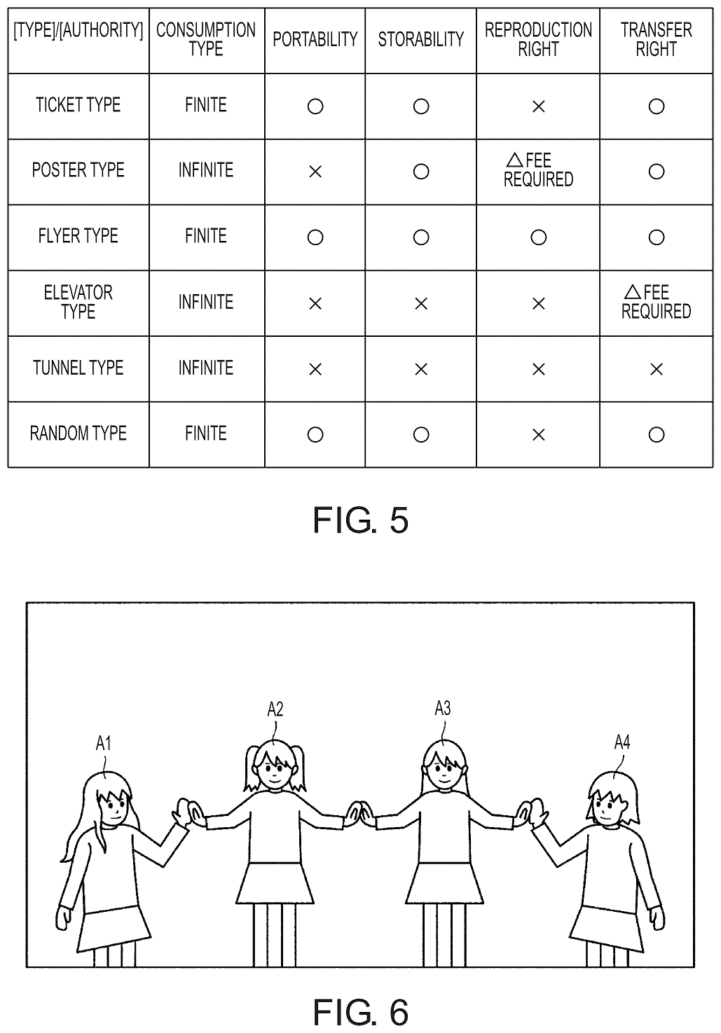

FIG. 5 is a table showing an example of portal attributes that can be set in this embodiment.

In this embodiment, the portal attributes include characteristic or authority elements, and may specifically include consumption type, portability, storability, a reproduction right, a transfer right, or the like, as shown in FIG. 5.

In this case, each portal may be associated with a setting state of whether it can be consumed when used by an avatar as a setting state related to the consumption type. For example, a portal with consumption set to “finite” may disappear (be consumed) when used. In this case, a consumption condition may be associated with a portal for which consumption is set to “finite.”

Furthermore, each portal may be associated with a setting state of whether it can be carried by an avatar as a setting state related to portability. For example, a portal for which carrying by an avatar is set to “possible (◯)” may be allowed to be carried by an associated avatar (moved within the virtual space). Instead of or in addition to the setting state related to portability, a setting state as to whether the portal is fixed in the virtual space may be associated. In this case, for example, a portal that is set to “fixed” may be disabled from normal movement (movement in the virtual space) other than movement by a specific avatar (for example, an avatar of an installer of the portal, an avatar of an operator, or the like).

Further, each portal may be associated with a setting state as to whether it is stored in a pocket of the avatar's clothing or inside the avatar as a setting state related to storability. For example, a portal whose storability is set to “Possible (◯)” may be allowed to be stored in a pocket or the like of the associated avatar (for example, stored in a reduced size). In this case, even a relatively large portal can be easily moved within the virtual space (movement due to portability). Also, the portal does not need to be drawn while it is stored, and the processing load can be reduced.

Further, each portal may be associated with a setting state indicating whether duplication is permitted as a setting state related to a duplication right. For example, a portal whose duplication right is set to “allowed (◯)” may be allowed to be duplicated (copied) under a certain condition. In this case, it becomes easy to install a plurality of similar portals in the virtual space.

In addition, each portal may be associated with a setting state of transferability as a setting state related to a transfer right. For example, a portal whose transfer right is set to “possible (◯)” may be transferable to another avatar under a certain condition. In this case, it is also possible to make the portal an asset as a transaction object.

In this embodiment, the portal attributes include a type element as a form, and specifically, as shown in FIG. 5, may include ticket type, poster type, flyer type, elevator type, tunnel type, random type, or the like. The flyer type is typically in the form of a leaflet. Although several types are exemplified here, the portal can take any form as long as its existence can be visually recognized by the avatar (user).

In this case, the relationship between the type as a form and the setting state related to the above-mentioned characteristic or authority element may be associated in advance as shown in FIG. 5 according to a characteristic in reality related to the form of the type. For example, in the example shown in FIG. 5, the ticket type is consumable, portable, storable, non-duplicatable, and transferable, just like a real ticket. In FIG. 5, “A (fee required)” means “0 (possible)” with a fee.

In this embodiment, the condition of use of each portal may preferably differ from portal to portal. In this case, it is possible to set usage conditions corresponding to a diversification of portal attributes as described above.

A portal usage condition is a condition that must be met in order to use (pass through) the portal. The usage condition of one portal may be freely set by a specific avatar (for example, the avatar of the installer of the portal, the avatar of the operator, or the like). This will further diversify the portals and make it easier for the specific avatar to adjust the usability of the portal, improving convenience.

In this embodiment, a portal that is used by a plurality of avatars at the same time is set. In other words, a portal is set up that cannot be used by just one avatar. The usage condition for the portal with such an attribute preferably includes a condition regarding the number of avatars that can move at the same time. The upper limit regarding the number of avatars may be defined by an upper limit number of avatars or a lower limit number of avatars. Hereinafter, a type of portal that can only be used by a plurality of avatars at the same time is also referred to as a “portal type that allows a plurality of avatars to pass through.”

For example, for an elevator-type portal, a condition for using the elevator-type portal may be met by gathering a predetermined number of avatars. The predetermined number may be a constant number, or may be dynamically varied. FIG. 6 is an explanatory diagram showing an example of a portal usage condition. In the example shown in FIG. 6, four avatars A1 to A4 are holding hands. In this way, a usage condition of a certain portal may be satisfied when a predetermined number or more of avatars hold hands in the vicinity of the portal (that is, the position or area associated with the portal).

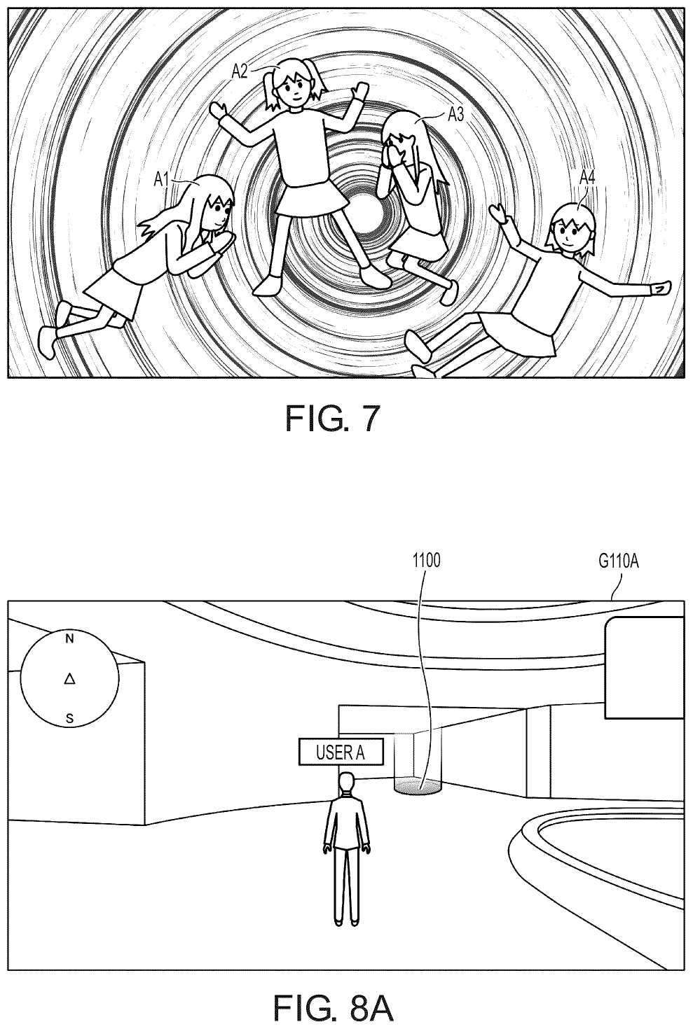

As in the case of this type of portal that allows a plurality of avatars to pass through, if the usage condition of the portal includes a condition regarding the number of avatars that can move at the same time, for example, it is possible for friends to move together through the portal. Thus, it is possible to enjoy the process during the movement. In addition, it is possible to increase the expectation of enjoyment at the destination. For example, FIG. 7 is a diagram that schematically shows a state of moving through a portal. In FIG. 7, movement through the portal is realized by an image of being sucked into a hole such as a black hole, but it may be realized by an image of riding in a vehicle or the like. Also, if the portal is related to a vehicle such as an elevator type, a situation in which the portal itself moves (for example, when the portal is in the form of a car or bus, a situation in which the surrounding scenery changes from the car window) may be drawn.

Furthermore, a predetermined video may be output to moving avatars while moving through the portal. The predetermined video may be output to the background, a display section of the vehicle, or the like. In this case, the predetermined video may be generated based on avatar information or user information associated with the moving avatars. For example, the predetermined video may include a video that evokes a common memory or the like based on avatar information or user information of each moving avatar.

Here, in this specification, various videos may be generated based on motion data for generating the videos (for example, movements of moving objects such as avatars that may be included in the videos) and avatar information of the avatars (see FIG. 15). In this case, the motion data may be generated based on motions that operate to move the avatar, facial expressions, voice reproduction, sound effect reproduction, and the like. Also, even if a predetermined video has the same attribute, the video itself may differ according to the avatar(s) that appears. For example, after outputting destination information such as “I heard that no matter how strong a person has tried to pull out a legendary sword at the end of this portal, it couldn't be pulled out,” as a predetermined video, the motion and expression of a moving avatar trying to pull out the sword with all its strength may be digest-reproduced together with sound effects.

Also, while moving through the portal, the clothing and possessed items of the moving avatar may be changed to clothing and possessed items corresponding to an attribute of the destination. That is, a change of clothes, transformation, or the like may be realized. For example, if the destination is a ballpark (baseball field) and the purpose is to cheer, the user may be changed into the uniform of the team s/he favors, provided with a megaphone for cheering, or the like.

Also, while moving through the portal, it may be possible to have conversations between moving avatars. For example, while moving through the portal, a plurality of moving avatars can have a lively conversation while viewing the above-described predetermined video.

Incidentally, if implemented in a game or the like, an animation in the movement at the portal can be implemented as a production during loading to memory (a production to give a pause), as an implementation to stall for time, or as a story explanation during scene transitions. On the other hand, in a metaverse space, the player character and surrounding avatars are not necessarily characters that can be prepared in advance. Since each player character can be an avatar designed with a different world view, it is necessary to change the clothes and equipment to match the world view of the destination. Therefore, while moving through the portal, it is preferable that the movement be accompanied by a presentation for which the user's consent has been obtained. There is also a user(s) who becomes a “viewer” who observes and enjoys the actions of the players. Therefore, it would be useful to be able to have communication between the viewer and other players while moving through the portal.

The condition for using one portal may be dynamically changed based on a state (particularly, a dynamically changeable state) related to the destination to which the user can move via the one portal. For example, in this case, when a degree of congestion (density or the like) of a destination related to one portal exceeds a predetermined threshold, the usage condition related to that one portal may be changed to be more strict than normal. In this case, the usage condition related to the one portal may be changed such that the portal is substantially unusable. Alternatively, the usage condition related to the one portal may be changed in multiple steps. In addition, the usage condition of one portal may be changed such that if trouble occurs, such as the appearance of an avatar that behaves suspiciously or causes nuisance at a destination that can be moved to through that one portal, the portal becomes substantially unusable.

Incidentally, although this type of portal is highly convenient, avatars tend to hesitate to use it if they do not know the information regarding the destination.

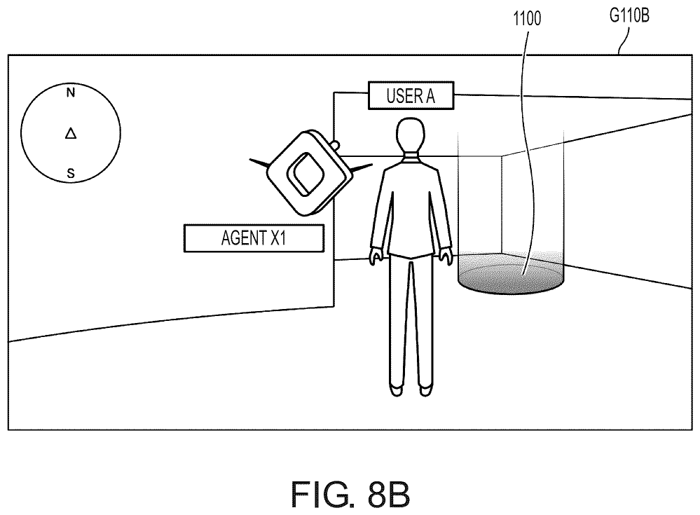

Therefore, in this embodiment, agent avatars may be used, and various guidance processes may be executed in association with portals. FIGS. 8A and 8B are explanatory diagrams of an example of a guidance process by an agent avatar associated with each avatar.

FIG. 8A shows an example of a terminal image G110A in which avatar A has arrived in front of a portal 1100, and FIG. 8B shows an example of a terminal image G110B in a state in which an agent avatar (shown as “agent Xl” in FIG. 8B) associated with avatar A is produced. Hereinafter, the agent avatar (first predetermined object, an example of a first avatar) generated in such a manner as to accompany the avatar is also referred to as a “first agent avatar.” The first agent avatar may be an avatar that operates automatically based on an artificial intelligence algorithm, a pre-prepared algorithm, or the like.

Additionally, the first agent avatar may be placed not only by a developer's advance preparation, but also by a general user (moderator) who designs and sets up the metaverse. In this case, unlike conventional methods proposed by software algorithms such as artificial intelligence and agents, which have been designed according to the purpose of a service at a service provider side, it is useful to design as a general-purpose interface that can be used by a user for creative purposes. For this purpose, programmable elements may be provided that can simply describe and process complex logic using variables, scripts, and the like. In addition, there may be selectivity based on user attributes such that the first agent avatar is displayed only for users with different comprehension skills, such as novice uses and users who need tutorials.

The first agent avatar may constantly accompany avatar A, or may be produced only when avatar A is positioned near the portal 1100, as can be seen by contrasting FIGS. 8A and 8B. Alternatively, it may be produced in response to a request (user input) from avatar A.

In either case, the first agent avatar may output information about the destination when using the portal 1100 (hereinafter also referred to as “destination information”). Destination information may be output as characters, sounds, images (including videos), or any combination thereof. For example, when the destination information includes a video, the video may include a digest version of the video (preview video) that summarizes what the avatar can do at the destination.

Additionally, the form, voice quality, and the like of the first agent avatar may be selectable by the corresponding avatar (user). Also, the form of the first agent avatar may be changed according to the attributes of the portal located nearby.

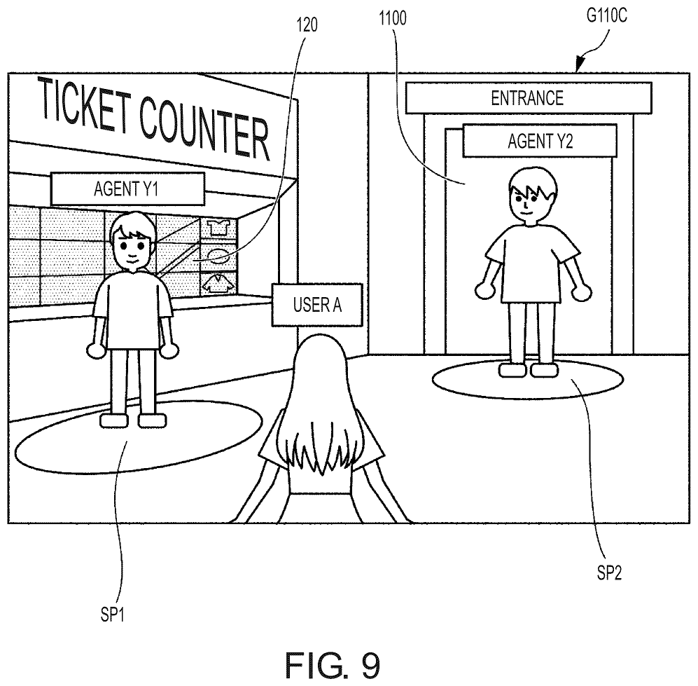

FIG. 9 is an explanatory diagram of agent avatars that are each linked with a position or area. FIG. 9 shows an example of a terminal image G110C in which two agent avatars (shown as “agent Y1” and “agent Y2” in FIG. 9) are positioned in the vicinity of the portal 1100. Hereinafter, an agent avatar (an example of a second predetermined object and a second avatar) that is thus linked with a position or an area will be referred to as a “second agent avatar” to distinguish it from the above-described first agent avatar. The second agent avatar may be an avatar that automatically operates based on an artificial intelligence algorithm, an algorithm prepared in advance, or the like, or an avatar that is associated with a specific user (for example, a user associated with a destination). In the latter case, for example, if the destination is a specific facility, the second agent avatar may be a staff avatar dispatched from the specific facility.

In either case, the second agent avatar may be linked with the portal 1100 or to an area (set of positions) including the portal 1100. Also, one second agent avatar may be linked with an area including a plurality of portals. In this case, the one second agent avatar may perform various guidance at the plurality of portals.

In FIG. 9, as an example, a portal 1100 is shown that enables movement to, for example, a movie theater. In this case, an information center and an entrance are set, and two agent avatars Y1 and Y2 (shown as “agent Y1” and “agent Y2” in FIG. 9) are associated with the information center and the entrance. The agent avatar Y1 at the information center may provide information on movies being shown at the movie theater, a ticket sales location, and the like in a corresponding area SP1. Alternatively, the agent avatar Y1 at the information center may sell tickets. In this case, ticket sales (settlement) may be realized by a smart contract. The smart contract may be realized via a distributed network or the like. Also, the agent avatar Y2 at the entrance may perform guidance for entrance management, such as picking up a ticket, in a corresponding area SP2.

Additionally, in the example shown in FIG. 9, a display device 120 (second object M3) such as digital signage is installed at the information center. In this case, the display device 120 may display a digest version of a video or the like that summarizes the content of a movie that the avatar can view at the destination (movie theater). Also, the first agent avatar may be accompanied even under the situation shown in FIG. 9. In this case, the first agent avatar may notify the corresponding avatar of the information obtained from the second agent avatar.

Incidentally, as in the case of the portal that allows a plurality of avatars to pass through, if the usage condition includes a condition regarding the number of avatars, a mechanism may be set to promote interaction among avatars in order to align the number of avatars to pass through the portal.

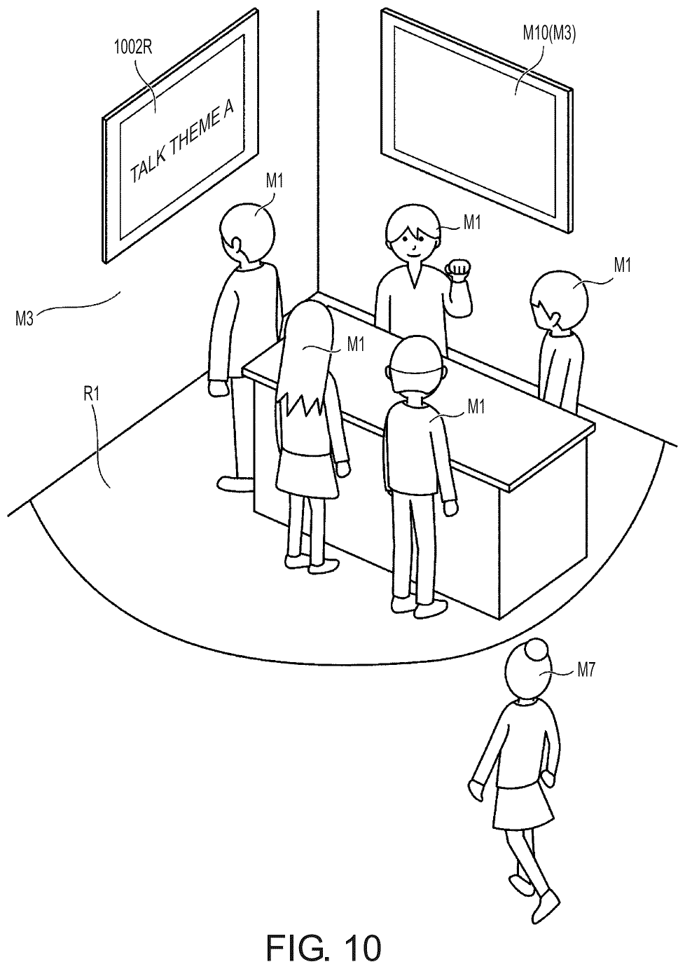

For example, in FIG. 10, a situation of a plurality of avatars waiting to use a specific portal is shown schematically. In this case, the condition for using the specific portal is satisfied when six or more avatars are positioned within area R1 and all avatars hold hands. Therefore, in the state shown in FIG. 10, the condition for using the specific portal is not satisfied, and five avatars M1 are waiting. Destination information may be provided to the waiting avatars for such area R1. For example, the destination information may be displayed on an image such as a poster, may be sound-composed as a speech of the first agent avatar or the second agent avatar, or may be displayed in the space like a balloon. In the example shown in FIG. 10, a wall portion (second object M3) may be associated with a display medium 1002R indicating a talk theme related to the destination or a talk theme related to conversation between waiting avatars. At this time, the display medium 1002R may include character information or the like representing the corresponding talk theme. The display medium 1002R may be installed at a position that is easily visible from the viewpoint of an avatar M7 who is about to enter the area R1 as another user. This makes it possible to promote the participation of external avatars (use of specific portals). Also, the avatars M1 inside the area R1 can invite or the like the outside avatar M7. A second agent avatar associated with the destination may exist within the area R1. In this case, guidance processing to the outside avatar M7 or the like may be realized view the second agent avatar.

Additionally, in the example shown in FIG. 10, a display object M10 (second object M3) or the like that can be viewed by each avatar may be arranged in the area R1. The display object M10 may display the above-described preview video or the like as destination information. As a result, communication between avatars waiting in the area R1 and appeal to avatars outside the area R1 are promoted, and utilization of the portal by the avatars can be promoted.

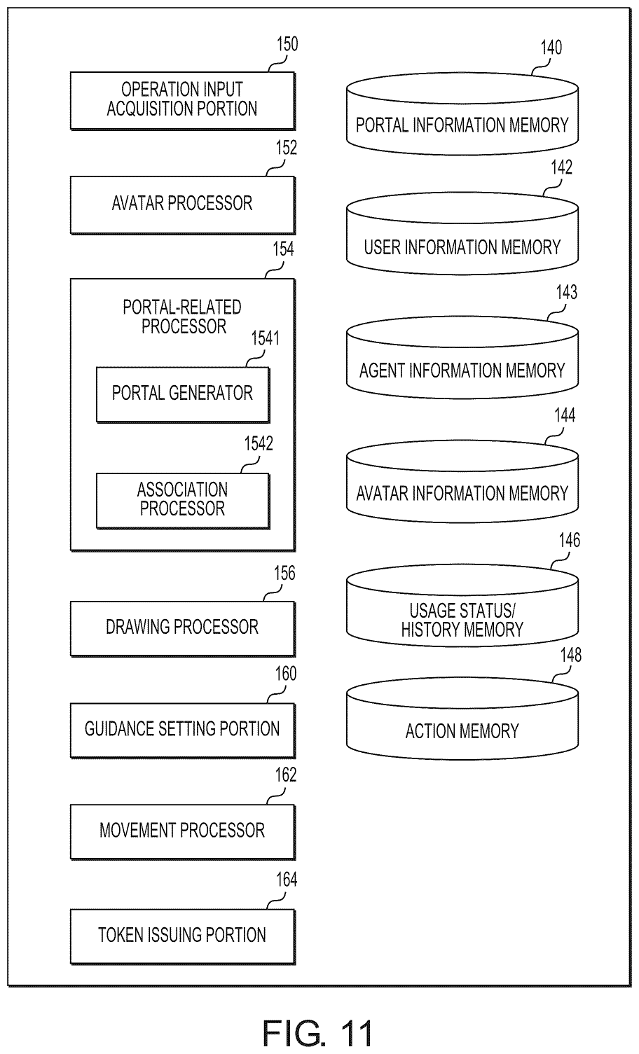

Next, referring to FIG. 11 and after, a function related to the above-described portal (hereinafter also referred to as a “portal function”) will be further explained.

Hereinafter, the server device 10 that performs processing related to the portal function realizes an example of an information processing system. As described hereafter, each element of one specific terminal device 20 (see the terminal communicator 21 to the terminal controller 25) may implement an example of an information processing system, or a plurality of terminal devices 20 may cooperate to implement an example of an information processing system. Also, the server device 10 and one or more terminal devices 20 may cooperate to implement an example of an information processing system.

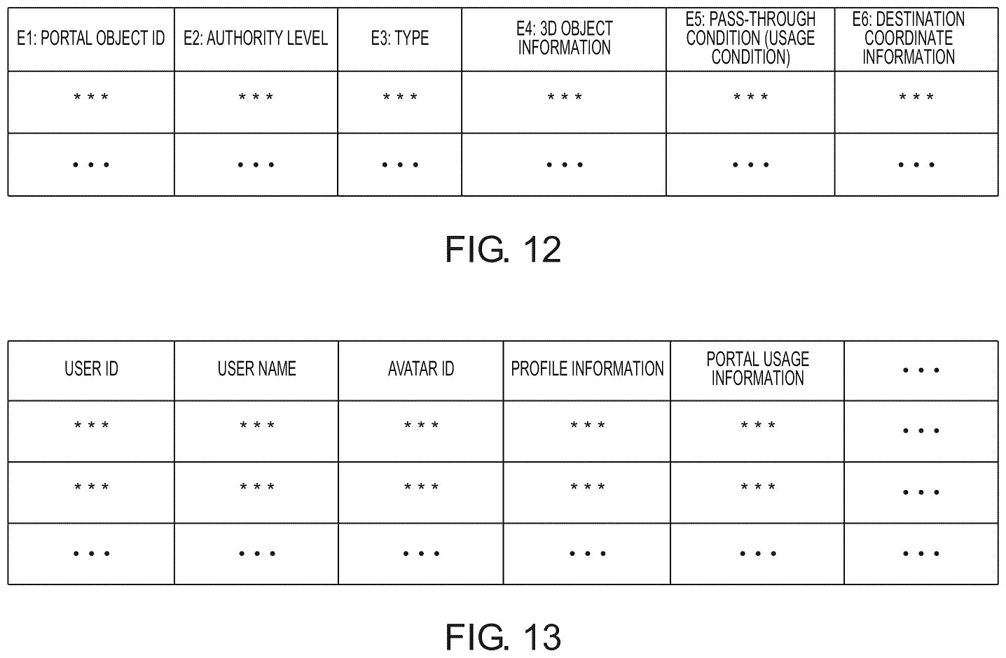

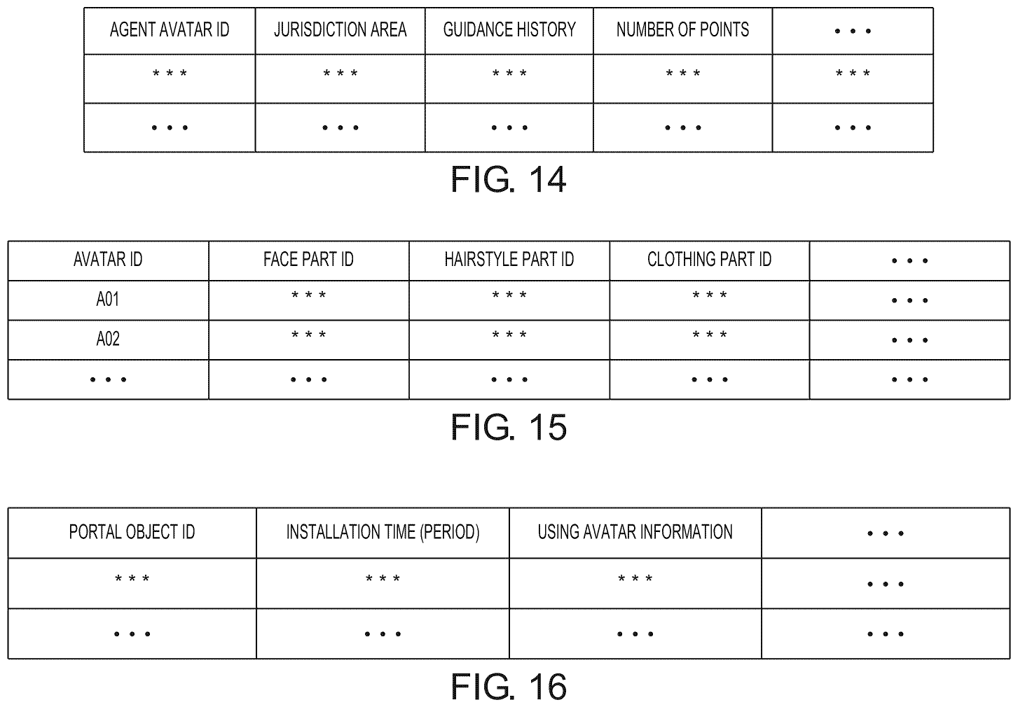

FIG. 11 is an example of a functional block diagram of a server device 10 related to a portal function. FIG. 12 is an explanatory diagram of data within a portal information memory 140. FIG. 13 is an explanatory diagram of data within a user information memory 142. FIG. 14 is an explanatory diagram of data within an agent information memory 143. FIG. 15 is an explanatory diagram of data within an avatar information memory 144. FIG. 16 is an explanatory diagram of data within a usage status/history memory 146. In FIGS. 12 to 16, “***” indicates a state in which some information is stored, “-” indicates a state in which no information is stored, and “ . . . ” indicates repetition of the same.

As shown in FIG. 11, the server device 10 includes the portal information memory 140, the user information memory 142, the agent information memory 143, the avatar information memory 144, the usage status/history memory 146, and an action memory 148. The portal information memory 140 to the action memory 148 can be realized by the server memory 12 shown in FIG. 1, and an operation input acquisition portion 150 to a token issuing portion 164 can be realized by the server controller 13 shown in FIG. 1.

Also, as shown in FIG. 11, the server device 10 includes the operation input acquisition portion 150, an avatar processor 152, a portal-related processor 154, a drawing processor 156, a guidance setting portion 160, a movement processor 162, and the token issuing portion 164.

Part or all of the functions of the server device 10 described below may be realized by the terminal device 20 as appropriate. In addition, classification of the portal information memory 140 to the action memory 148 and classification of the operation input acquisition portion 150 to the token issuing portion 164 are for the convenience of explanation, and some functional portions may realize the functions of other functional portions. For example, part or all of the functions of the avatar processor 152 and the drawing processor 156 may be realized by the terminal device 20. Also, for example, part or all of the data in the user information memory 142 may be integrated with the data in the avatar information memory 144, or may be stored in another database.

The portal information memory 140 stores portal information regarding various portals that can be used in the virtual space. The portal information stored in the portal information memory 140 may be generated by the user as will be described hereafter in relation to the portal-related processor 154. For example, a portal may be generated as a UGC (User Generated Content). In this case, the data (portal information) in the portal information memory 140 described above constitutes the UGC. In the example shown in FIG. 12, portal information includes six elements E1 to E6 for each portal.

Element E1 is a portal object ID, which is an identifier assigned to each portal. The portal object ID may include the user ID that created the corresponding portal, but the user ID may be omitted for portals with transferable attributes. The portal object ID may require a fee (charge) for issuance.

Element E2 indicates an authority level. The authority level represents the authority for editing portal information and the like, and indicates whether the portal is operated by the operator or created by the user. Also, the authority level may be extensible, such as time-limited, valid only in the world, valid globally, or the like.

Element E3 represents an attribute of the portal described above with reference to FIG. 5. The attribute of the portal may be automatically determined according to the type of the portal (for example, the ticket type, the poster type, and the like shown in FIG. 5).

Element E4 represents 3D object information (drawing data) of the portal, and may be created (customized) by the user.

Element E5 represents a usage condition (pass-through condition) of the portal. The usage condition of the portal is as described above with reference to FIG. 6 and the like. The portal usage condition may be described by, for example, script. In addition, the portal usage condition may be described in a format that automatically redirects to a URL (Uniform Resource Locator) for usage condition determination. In this case, the user does not have to create a portal usage condition, which improves convenience. Similarly, when settlement is included in the portal usage condition, a URL for a smart contract may be described.

For example, a usage condition for a portal that says “You are friends, the number of people is 4, and a Warp emote will be reproduced” may be described as follows. “Friends==true & GroupNum==4&Emote, Warp” Also, Emote==Warp means that the Warp emote will be reproduced (each avatar performs the Warp operation). In an example of determining such portal usage condition using an externally linked API (Application Programming Interface), the following Web request may be generated. “https://gate segue st/?Friend=true&GroupNum=4 &Emote=Warp &key=12345” In this case, a key character string {key=12345} is added for security measures. The externally linked API designates {Friend, GroupNum, Emote}. In this case, if the Web request returns a success response (for example, “200”), the server device 10 side makes a determination such as passing, and if an error response (for example, “400”) is returned, the portal cannot be used.

Element E6 represents coordinate information of a destination when the portal is used. The coordinate information of the destination does not have to be one point, and may be expressed as a set (area). The coordinate information of the destination may be described in any form, but may be described in, for example, URL format. In this case, for example, the coordinate information of the destination may be described as follows. metaportal://vrsns. * * * . app/world/? wid: 123-4567&lat=72.3&lon=12.5&objid=door1 In this case, metaportal is a protocol name, and vrsns. * * * . app is an FQDN (Fully Qualified Domain Name) of a server that provides the service (that is, the server device 10). This FQDN is a name that can be resolved by a DNS (Domain Name System) server (an element of the server device 10), and in reality, multiple redundant servers may respond. Wid is a world ID and may include, for example, the ID given to each spatial portion 70 described above with reference to FIG. 2. In this case, an instance can be acquired by inquiring of the above-mentioned server or the like that cooperates. lat and lon are the latitude and longitude of the destination, and may actually be coordinates such as x, y, and z. The latitude and longitude of the destination may be implemented in a key-value type table together with the world ID. Also, objid is an object ID connected to the portal. For example, in the case of a round-trip type portal, an ID of an object in the world or the ID of a 3D object to be displayed can be designated. In the case of the round-trip type portal, if a portal exists at the same coordinates as the destination, an infinite loop may occur. Element E6 may be set so that such an infinite loop does not occur.

The element E6 may contain information representing an attribute of the destination. The attribute of the destination may be any attribute related to the attribute of the content that can be provided at the destination, the size of the area of the destination, a method of returning from the destination (round trip type, and the like), and the like.

The user information memory 142 stores information regarding each user. Information regarding each user may be generated, for example, at the time of user registration, and then updated or the like as appropriate. For example, in the example shown in FIG. 13, the user information memory 142 stores a user name, an avatar ID, profile information, portal usage information, and the like in association with user IDs. Of the information in the user information memory 142, part of the information related to one user may be used to determine whether the condition for using the portal related to the avatar associated with the one user is established.

The user ID is an ID that is automatically generated at the time of user registration.

The user name is a name registered by each user himself/herself and is arbitrary.

The avatar ID is an ID representing the avatar used by the user. The avatar ID may be associated with avatar drawing information (see FIG. 15) for drawing the corresponding avatar. The avatar drawing information associated with one avatar ID may be able to be added, edited, or the like based on input from the corresponding user.

The profile information is information representing a user profile (or avatar profile), and may be generated based on input information from the user. Also, the profile information may be selected via a user interface generated on the terminal device 20 and provided to the server device 10 as a JSON (JavaScript Object Notation) request or the like.

The portal usage information includes information representing the usage history or the like of each portal by the corresponding avatar. The portal usage information is consistent with the using avatar information described hereafter with reference to FIG. 16, and one of them may be omitted.

The agent information memory 143 stores agent information regarding each agent avatar. The agent information includes information regarding the second agent avatar out of the first agent avatar and the second agent avatar described above. The agent information may include information such as jurisdiction area, guidance history, number of points, or the like for each agent avatar ID. The jurisdiction area represents a location or area linked with an agent avatar. The guidance history may include the history of guidance processing performed by the agent avatar in relation to the portal (date and time, companion avatar(s), and the like) as described above. The number of points is a parameter related to the evaluation of the agent avatar, and may be calculated and updated based on, for example, the frequency of guidance processing and the effectiveness rate (the number and frequency of times the avatar that performed the guidance processing used the portal). In this case, rewards or incentives according to the number of points may be given to the agent avatar.

Avatar drawing information for drawing each user's avatar is stored in the avatar information memory 144. Part of the information related to one avatar in the avatar information memory 144 may be used to determine whether the condition for using the portal related to the one avatar is satisfied. In the example shown in FIG. 15, in the avatar drawing information, each avatar ID is associated with a face part ID, a hairstyle part ID, a clothing part ID, and the like. Appearance-related parts information such as the face part ID, the hairstyle part ID, and the clothing part ID are parameters that characterize the avatar, and may be selected by each user. For example, a plurality of types of information related to appearance such as the face part ID, the hairstyle part ID, and the clothing part ID related to the avatar is prepared. Also, as for face part ID, part IDs are prepared for each type of face shape, eyes, mouth, nose, and the like, and information related to the face part ID may be managed by combining the IDs of the parts that constitute the face. In this case, it is possible to draw each avatar not only on the server device 10, but also on the terminal device 20 side, based on each ID related to the appearance linked with each avatar ID.

The usage status/history memory 146 stores the usage status or usage history of the portal by each avatar for each portal. In the example shown in FIG. 16, information representing an installation time (period), a using avatar, and the like is stored for each portal object ID. The installation time may represent the time (available time) during which the portal is installed in state in which it can be used by avatars. Using avatar information is information representing an avatar that uses the corresponding portal. The using avatar information may include the number of avatars that used the portal, and the like, and in this case, it can represent a value (popularity or the like) of the corresponding portal. Therefore, in the case of a portal having an asset property (that is, in the case of a portal in which the transfer right described above with reference to FIG. 5 is set to “Yes (◯)”), the value of the portal may be calculated or predicted.

The action memory 148 stores actions performed in relation to the portal for each avatar. The actions to be stored are arbitrary, but actions that become memories are preferable. For example, when one avatar moves to a corresponding destination via one portal, an action of the one avatar (for example, taking a commemorative photo with other avatars) while moving to the destination may be stored. Also, when one avatar moves to a corresponding destination via one portal, an action of the one avatar at the destination (for example, an activity performed with other avatars) may be stored. The data stored in the action memory 148 may include image data (that is, terminal image data) of a virtual camera pertaining to the corresponding avatar.

The operation input acquisition portion 150 acquires various user inputs input by each user via the input portions 24 of the terminal devices 20. Various inputs are as described above.

For each avatar, the avatar processor 152 determines the movement of the avatar (change in position, movement of each part, and the like) based on various inputs by corresponding users.

The portal-related processor 154 stores and updates data in the portal information memory 140 described above. The portal-related processor 154 includes a portal generator 1541 and an association processor 1542.

The portal generator 1541 generates a portal(s) in the virtual space. The portal is described above. Generating a portal includes issuing a portal object ID as described above. The portal generator 1541 generates a portal based on a generation request (user input) from a user who intends to generate a portal. A condition for generating a portal is arbitrary, but may be set for each portal attribute. For example, in the case of a non-portable portal, a condition for creating the portal may include a condition regarding ownership and usage rights of the land on which the portal is to be placed.

The association processor 1542 associates a portal use condition, a portal attribute, and a destination (specific destination) attribute with each portal. The portal attributes and destinations are as described above in relation to the portal information memory 140. In this case, the association processor 1542 adds the data related to one portal in the portal information memory 140, whereby the usage condition of the portal, the portal attribute, and the destination (specific destination) attribute can be associated with the portal.

The association processor 1542 may dynamically change the portal usage condition of a specific portal. In this case, the association processor 1542 may dynamically change the portal usage condition according to various states (various states that can change dynamically) of the destination related to the portal. Such dynamic changes may be as described above.

The drawing processor 156 generates an image for viewing on the terminal device 20 (terminal image), which is an image of the virtual space including the avatar. The drawing processor 156 generates an image for each avatar (an image for the terminal device 20) based on the virtual camera associated with each avatar.

The guidance setting portion 160 sets predetermined guidance processing via the above-described first agent avatar or predetermined guidance processing via the above-described second agent avatar. Predetermined guidance processing includes guidance processing related to portals, and the guidance processing related to portals may be as described above with reference to FIGS. 8A to 9.

The movement processor 162 determines whether one or more avatars meet the usage condition of one portal, and if the usage condition is satisfied, the one or more avatars can use the one portal. Determination of the portal usage condition may be realized by any method, but may be determined using, for example, an externally linked API as described above.

When the usage condition of one portal is satisfied for one or more avatars, the movement processor 162 may automatically perform the process of moving to the destination via the portal, or may perform the process of moving to the destination via the portal in response to a new predetermined user input.

Further, the movement processor 162 outputs a predetermined video while moving to the destination via the portal. The predetermined video is as described above. For example, the movement processor 162 may generate a predetermined video based on avatar information or user information associated with the avatar. Further, the movement processor 162 may be capable of executing a game (mission), quiz, or the like related to the destination while moving to the destination via the portal. In this case, benefits may be given at the destination according to the results of the game or quiz.

In addition, the movement processor 162 may further associate an item or object corresponding to the destination with the avatar. Items or objects corresponding to the destination are as described above. For example, if the destination is a tropical island, items or objects corresponding to the destination may include light clothing such as Aloha shirts and beach sandals.

If the condition for using one portal is not satisfied for one or more avatars, the movement processor 162 may notify the avatar(s) to that effect via the first agent avatar or the second agent avatar.

The token issuing portion 164 issues a non-fungible token (NFT) based on the data in the action memory 148. In this case, the user can issue data related to the experience obtained through his/her own avatar (for example, video data such as scenery viewed through a virtual camera) as a non-fungible token. In this case, data related to the experience can have its owner and its ownership transfer recorded using blockchain, or can be duplicated or discarded through a fee-based request or a free request. In this case, the data related to the experience is not limited to processing within the system related to the virtual reality generation system 1 using blockchain, but also can have its owner and its ownership transfer recorded, and it can be duplicated or discarded through a fee-based request or a free request in a market, smart contract, or distributed processing module outside the system related to the virtual reality generation system 1.

The sharing of functions between the server device 10 and the terminal device 20 described above is merely an example, and various modifications are possible as described above. That is, part or all of the functions of the server device 10 may be realized by the terminal device 20 as appropriate. For example, part or all of the functions of the drawing processor 156 may be realized by the terminal device 20. In the case of such a client rendering type configuration, the drawing processor 156 may generate an image generation condition for drawing a terminal image. In this case, the terminal device 20 may generate a virtual DOM (Document Object Model) and draw a terminal image by detecting a difference based on the image generation condition that is sent from the server device 10.

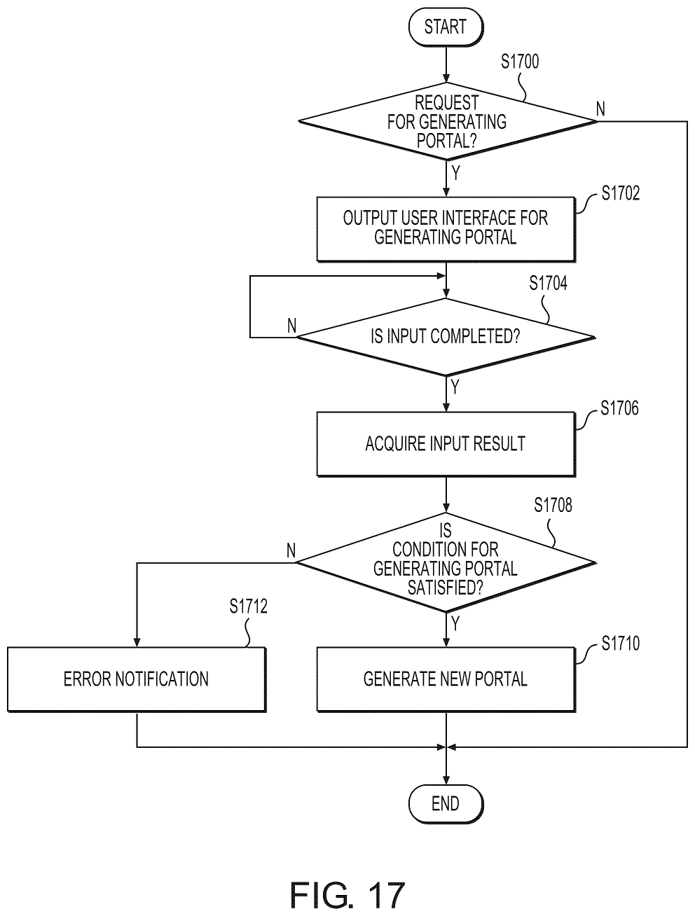

Next, referring to FIG. 17 and after, an operation example of the virtual reality generation system 1 relating to the portal function described above will be described.

FIG. 17 is an outline flowchart showing an operation example relating to portal generation processing through the portal-related processor 154 described above.

In step S1700, the portal-related processor 154 determines whether a portal generation request has been received from a user. The user's request to create a portal may be generated in any manner. If the determination result is “YES,” the process proceeds to step S1702; otherwise, the process for this cycle ends.

In step S1702, the portal-related processor 154 outputs a user interface for generating a portal via the terminal device 20 pertaining to the requesting user. The user interface for generating a portal may be generated in such a manner as to be superimposed on the terminal image. The user interface for generating a portal is a user interface for the user to generate (describe) portal information as described above.

In step S1704, the portal-related processor 154 determines whether the user's input to the user interface for generating a portal is completed. Completion of input may be generated through a confirmation operation by the user or the like. If the determination result is “YES,” the process proceeds to step S1706; otherwise, the process waits for completion of input. If the waiting state continues for a certain period of time or more, the process may end.

In step S1706, the portal-related processor 154 acquires the user's input result with respect to the user interface for generating a portal.

In step S1708, the portal-related processor 154 determines whether the condition for generating a portal is satisfied based on the user's input result. The condition for generating a portal is as described above. If the determination result is “YES,” the process proceeds to step S1710; otherwise, the process proceeds to step S1712.

In step S1710, the portal-related processor 154 generates a new portal based on the user's input result. In this case, the portal-related processor 154 may issue a new portal object ID and update the data in the portal information memory 140.

In step S1712, the portal-related processor 154 issues an error notification indicating that the condition for generating a portal is not satisfied. In this case, the error notification may be realized via the user interface for generating a portal.

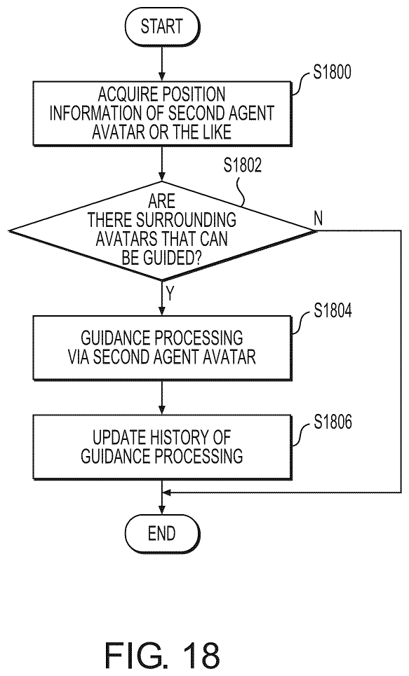

FIG. 18 is an outline flowchart showing an operation example relating to guidance processing through the guidance setting portion 160. FIG. 18 shows guidance processing via one second agent avatar, and guidance processing via each second agent avatar may be performed in parallel in a similar manner.

In step S1800, the guidance setting portion 160 acquires position information of a subject second agent avatar and position information of each avatar.

In step S1802, the guidance setting portion 160 determines whether there are surrounding avatars that the second agent avatar can guide, based on each piece of position information obtained in step S1800. Surrounding avatars that can be guided by the second agent avatar may include (i) an avatar located within a predetermined distance from the second agent avatar, (ii) an avatar located within a predetermined distance from the subject portal linked with the second agent avatar, and the like. If the determination result is “YES,” the process proceeds to step S1804; otherwise, the process ends.

In step S1804, the guidance setting portion 160 executes guidance processing via the second agent avatar. The content of the guidance processing via the second agent avatar may be defined in advance. As described above, the second agent avatar may be an agent entrusted by an administrator of a destination facility or the like. In this case, a consignor may designate a URL related to the agent in order to use an API prepared in advance. As a result, the consignor can realize guidance processing via the second agent avatar without having to create a detailed condition.

In step S1806, the guidance setting portion 160 updates the history of the guidance processing by the second agent avatar (see “guidance history” in FIG. 14) in response to the execution of the guidance processing by the second agent avatar. In this case, information indicating whether the portal has been used due to guidance processing (that is, information regarding the effectiveness of the guidance processing) may be stored at the same time.

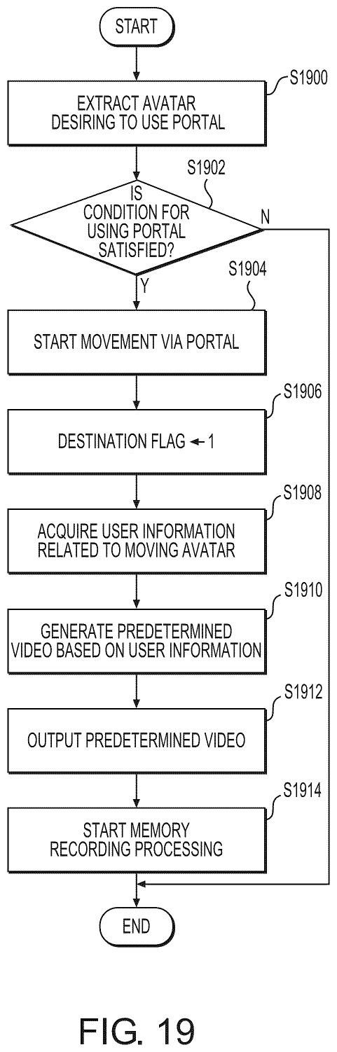

FIG. 19 is an outline flowchart showing an operation example relating to processing through the movement processor 162. FIG. 19 shows processing related to one portal (hereinafter also referred to as a “this portal”), and processing related to each portal may be executed in parallel in a similar manner.

In step S1900, the movement processor 162 extracts an avatar(s) desiring to use a portal from among the avatars around the portal. The avatar desiring to use the portal may include, for example, an avatar existing within an area linked with the portal, an avatar requesting use based on user input, or the like.

In step S1902, the movement processor 162 determines whether the one or more avatars extracted in step S1900 satisfy the portal usage condition. In addition, if this portal is a portal that allows a plurality of avatars to pass through, it is also possible to extract a plurality of avatars who wish to travel together, and determine whether the extracted avatars meet the usage condition of this portal. If the determination result is “YES,” the process proceeds to step S1904; otherwise, the process for this processing cycle ends.

In step S1904, the movement processor 162 starts the movement via the portal for one or more avatars who satisfy the portal usage condition.

In step S1906, the movement processor 162 sets a destination flag to “1.” The destination flag is set to “1” during (i) movement to the destination using the portal, (ii) staying at the destination, and (iii) returning from the destination. That is, the destination flag is a flag that is “1” from the start of movement via the portal to movement from the destination to the original location (or another new destination).

In step S1908, the movement processor 162 acquires user information related to one or more moving avatars.

In step S1910, the movement processor 162 generates a predetermined video based on the user information acquired in step S1908. The predetermined video is as described above. If the moving avatars are friends, the predetermined video may be a video or the like that reminds them of a common memory. Alternatively, the predetermined video may include a video such as a tutorial related to the destination.

In step S1912, the movement processor 162 outputs the predetermined video generated in step S1910 via the terminal device(s) 20 related to the corresponding avatar(s). As described above, the generation (drawing) of the predetermined video may be executed at the terminal device 20 side.

In step S1914, the movement processor 162 starts the processing of updating the data in the action memory 148 described above (hereinafter also referred to as “memory recording processing”) for each of the one or more moving avatars. Setting of the memory recording function may be switched on/off by an avatar. In this case, memory recording processing may be executed for the avatar(s) whose memory recording function is set to the ON state.

Here, the memory recording function basically records and reproduces actions in the metaverse world by saving motion data. Therefore, the recorded data may be reproducible together with logic for automatic reproduction such as sound effects and production, camera position information, or the like. Also, during reproduction, tone mapping such as black-and-white images or sepia processing may be applied to create an effect that evokes “memories.” In addition, it is possible to reproduce including changes in state such as changing clothes and acquiring items. At this time, transfer of ownership such as acquisition of an item during reproduction, and irreversible processing such as “destruction or death” may not be allowed to be processed. This is to suppress duplicate processing.

Data of memories may be compressed and stored together with a handler ID in the server device 10 or in the user's data area. For example, the handler ID is described on the NFT, and the transfer and duplication of the data is accompanied when the ownership of the NFT is transferred. Compression and decompression processing is described in the handler, and it is in a format that can be played back and restored on other systems (for example, compression with an encrypted file such as ZIP format, cryptographic expansion described in the NFT). For compatibility, it may be converted to a standardized image or video such as MPEG.

In this case, original 3D avatar animation memories can be distributed as the largest reproduction format available on the platform, while maintaining “video as compatible format.” As a result, attractiveness of the providing platform can be enhanced while maintaining the non-commutative nature and circulation of the NFT.

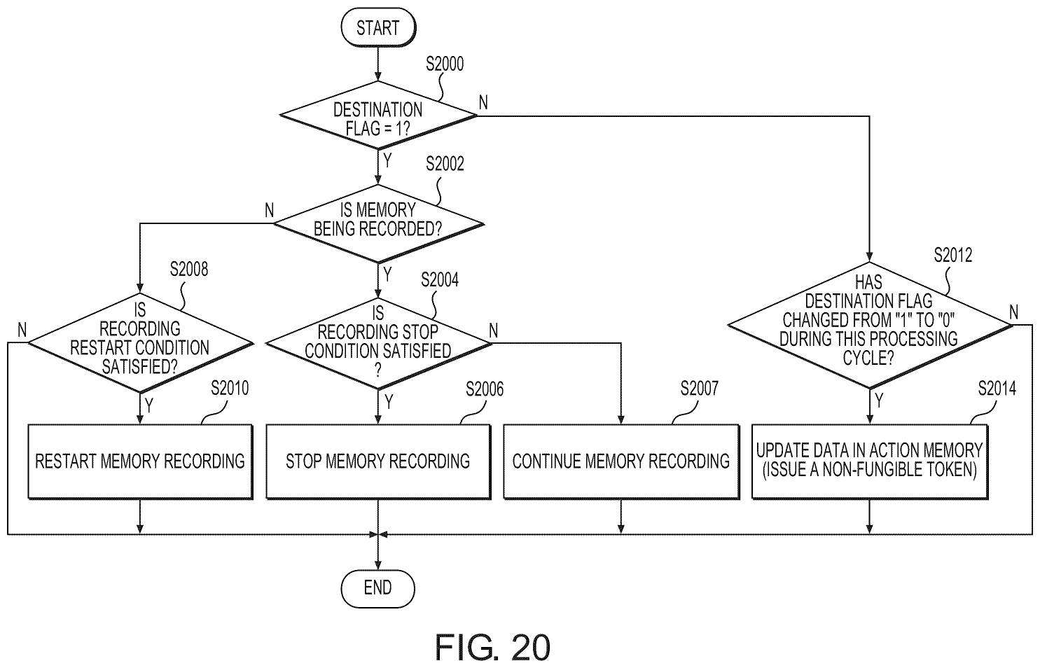

Hereinafter, referring to FIG. 20, a more specific example of the memory recording processing will be described.

FIG. 20 is an outline flowchart showing an operation example relating to memory recording processing through the movement processor 162. The processing shown in FIG. 20 may be executed in parallel for each avatar that is a subject for memory recording processing.

In step S2000, the movement processor 162 determines whether the destination flag is “1.” If the determination result is “YES,” the process proceeds to step S2002; otherwise, the process proceeds to step S2012.

In step S2002, the movement processor 162 determines whether a memory is being recorded. An image to be recorded by memory recording may be an image such as a landscape viewed from a virtual camera corresponding to the line of sight of the corresponding avatar. Alternatively, a virtual camera for memory recording that captures an avatar or the like may be set with a line of sight different from the line of sight of the corresponding avatar. If the determination result is “YES,” the process proceeds to step S2004; otherwise, the process proceeds to step S2008.

In step S2004, the movement processor 162 determines whether a recording stop condition is satisfied. The recording stop condition may be met, for example, when a stop instruction is given by the corresponding avatar. If the determination result is “YES,” the process proceeds to step S2006; otherwise, the process proceeds to step S2007.

In step S2006, the movement processor 162 stops memory recording.

In step S2007, the movement processor 162 continues memory recording. In this case, an image (video) related to memory recording may be stored in a predetermined storage area.

In step S2008, the movement processor 162 determines whether a recording restart condition is satisfied. The recording restart condition may be satisfied, for example, when the corresponding avatar issues a recording restart instruction. If the determination result is “YES,” the process proceeds to step S2010; otherwise, the current processing cycle ends.

In step S2010, the movement processor 162 restarts memory recording.

In step S2012, the movement processor 162 determines whether the destination flag in the previous processing cycle is “1.” That is, it is determined whether the destination flag has changed from “1” to “0” in the current processing cycle. If the determination result is “YES,” the process proceeds to step S2014; otherwise, the current processing cycle ends.

In step S2014, the movement processor 162 updates the data in the action memory 148, based on image data recorded during a period when the current destination flag is “1.” In this case, the token issuing portion 164 described above may issue a non-fungible token based on new image data or its processed data (data edited by the user). More specifically, motion data may be saved with the handler and stored. In this case, the stored data may be distributed within the virtual reality generation system 1 as is (for example, one song of a live music performance), or when distributed externally as an NFT, it may be rendered as an MPEG video and exported.

In the description of FIG. 17 and after, a case in which processing of each step is executed by the server device 10 has been described. However, as described above, the virtual reality generation system 1 (information processing system) according to this embodiment may be realized by the server device 10 alone. Alternatively, the server device 10 and one or more terminal devices 20 may work together to realize the virtual reality generation system. In the latter case, for example, an image generation condition may be sent from the server device 10 to a terminal device 20, and in the terminal device 20, the terminal image may be drawn based on the image generation condition. When drawing is performed at the terminal device 20 side, each object (for example, a portal) and the relationship with each object do not necessarily have to be drawn in the same way at each terminal device 20.

Although various embodiments have been described in detail above, the disclosure is not limited to specific embodiments, and various modifications and changes are possible within the scope described in the claims. It is also possible to combine all or a plurality of the constituent elements of the above-described embodiments.

For example, in the above-described embodiments, the memory recording process is executed with respect to movement through the portal, but may be executed independently of movement through the portal.

### EXPLANATION OF SYMBOLS

1 virtual reality generation system
3 network
10 server device
11 server communicator
12 server memory
13 server controller
20 terminal devices
21 terminal communicator
22 terminal memory
23 display portion
24 input portion
25 terminal controller
140 portal information memory
142 user information memory
143 agent information memory
144 avatar information memory
146 usage status/history memory
148 action memory
150 operation input acquisition portion
152 avatar processor
154 portal-related processor
1541 portal generator (specific object generator)
1542 corresponding processor
156 drawing processor
158 processor
160 guidance setting portion
162 movement processor
164 token issuing portion

1. An information processing system comprising:
one or more processors programmed to:
generate, in a virtual space, a specific object that enables an avatar to move to a specific position or a specific area in the virtual space, and
associate the specific object with (i) a condition for using the specific object and (ii) information regarding at least one of (a) an attribute of the specific object and (b) an attribute of the specific position or an attribute of the specific area.

2. The information processing system according to claim 1, wherein
the one or more processors are further programmed to set a predetermined guidance process (i) via a first predetermined object accompanying the avatar or (ii) via a second predetermined object linked with the specific position or the specific area.

3. The information processing system according to claim 2, wherein
the predetermined guidance process includes a process of outputting information regarding the specific position or the specific area.

4. The information processing system according to claim 3, wherein
the information regarding the specific position or the specific area includes a video pertaining to the specific position or the specific area.

5. The information processing system according to claim 3, further comprising
a first memory that stores a usage status or a usage history of the specific object by a plurality of the avatars.

6. The information processing system according to claim 2, wherein
the second predetermined object includes at least one of (i) a first avatar associated with an area including a position of the specific object and (ii) a second avatar associated with the specific position or the specific area.

7. The information processing system according to claim 1, wherein
the attribute of the specific object includes at least two of (i) a setting state of whether consumption of the specific object accompanying use by the avatar is possible, (ii) a setting state of whether the specific object can be carried by the avatar, (iii) a setting state of whether the specific object is fixed in the virtual space, (iv) a setting state of whether the specific object is stored in a pocket of clothing of the avatar or inside the avatar, (v) a setting state of whether duplication of the specific object is possible, and (vi) a setting state of whether ownership transfer of the specific object is possible.

8. The information processing system according to claim 1, wherein
the one or more processors set or update the condition for using the specific object based on a state pertaining to the specific position or the specific area.

9. The information processing system according to claim 1, wherein
the condition for using the specific object includes a condition regarding a number of avatars that can move at the same time.

10. The information processing system according to claim 1, wherein
the one or more processors are further programmed to output a predetermined video while the avatar is moving to the specific position or the specific area.

11. The information processing system according to claim 10, wherein
the one or more processors generate the predetermined video based on avatar information or user information associated with the avatar.

12. The information processing system according to claim 10, wherein
the one or more processors further associate, with the avatar, an item or an object corresponding to the specific position or the specific area.

13. The information processing system according to claim 1, further comprising
an action memory that, when the avatar moves to the specific position or the specific area via the specific object, stores at least one of (i) an action of the avatar during movement to the specific position or the specific area and (ii) an action of the avatar at the specific position or the specific area.

14. The information processing system according to claim 13, wherein
the one or more processors are further programmed to issue a non-fungible token (NFT) based on data stored in the action memory.

15. The information processing system according to claim 1, wherein
the one or more processors generate or update the condition for using the specific object based on user input from a specific user associated with the specific position or the specific area.

16. A non-transitory computer-readable medium storing thereon a program that causes a computer to execute:
generating, in a virtual space, a specific object that enables an avatar to move to a specific position or a specific area in the virtual space; and
associating the specific object with (i) a condition for using the specific object and (ii) information regarding at least one of (a) an attribute of the specific object and (b) an attribute of the specific position or an attribute of the specific area.

17. An information processing method comprising:
generating, in a virtual space, a specific object that enables an avatar to move to a specific position or a specific area in the virtual space; and
associating the specific object with (i) a condition for using the specific object and (ii) information regarding at least one of (a) an attribute of the specific object and (b) an attribute of the specific position or an attribute of the specific area.

18. An information processing device comprising:
one or more processors programmed to:
generate, in a virtual space, a specific object that enables an avatar to move to a specific position or a specific area in the virtual space, and
associate the specific object with (i) a condition for using the specific object and (ii) information regarding at least one of (a) an attribute of the specific object and (b) an attribute of the specific position or an attribute of the specific area.
